(19) United States
(12) Patent Application Publication
(10) Pub. No.: US 2022/0243513 A1
(43) Pub. Date: Aug. 4, 2022

(54) Door Stopper Device

(71) Applicant: Giuseppe Agostino, King (CA)

(72) Inventor: Giuseppe Agostino, King (CA)

(21) Appl. No.: 17/165,313

(22) Filed: Feb. 2, 2021

(51) Int. Cl. E05F 5/02

(52) U.S. Cl. CPC E05F 5/02; E05Y 2900/132

(57) ABSTRACT

A device for substantially preventing movement of a door; the device includes a first attachment plate, a second attachment plate, a hinge and a at least one stopper assembly. In some embodiments, the at least one stopper assembly includes a first stopper assembly and a second stopper assembly. The device is useful for preventing movement of a door past a desired position, is easily installed and does not require removal of door hardware to install.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of door stops of existing art and more specifically relates to door stops for preventing movement of a door past a desired position.

### Related Art

A doorstop is a device used to hold a door open or closed, or to prevent a door from closing or from opening too widely. For example, individuals may use a doorstop to prop their door open in order to circulate air throughout their house, or businesses may use doorstops in order to keep their doors open during business hours.

Conventionally, doorstops have involved the use of heavy objects placed next to a door, or wedges slid under a door. However, these doorstops are unsatisfactory as they are unsightly, potential trip hazards and often become dislodged or moved. Some attempts have been made to overcome these problems by attaching the doorstop to the door itself or on an adjacent wall. However, these attempts are not ideal as they require removal of door hardware, cause damage to the door, and/or can only be used on particular doors. Thus, a suitable solution is desired.

### SUMMARY OF THE INVENTION

In view of the foregoing disadvantages inherent in the known doorstop art, the present disclosure provides a novel door stopper device. The general purpose of the present disclosure, which will be described subsequently in greater detail, is to provide an easily installed door stopper device that holds a door in a desired position and does not require removal of door hardware to install.

A device for substantially preventing movement of a door is disclosed herein. The door is movable between an open position and a closed position via at least one door hinge and the open position includes a varying degree of open positions. The device may include a first attachment plate configured to attach to the door and a second attachment plate configured to attach to a door frame. The door frame is adjacent the door in use.

A hinge may be attached to the second attachment plate. At least one stopper assembly may be configured to selectively pivot about a vertical axis via the hinge. The at least one stopper assembly may include a body and a stopper rod. The body may have a left arm, a right arm and tubular head attached about a mid-section thereof. The left arm may include a fastener means configured to removably attach the left arm to the first attachment plate and the right arm may be fixedly attached to the hinge. Further, the stopper rod may be inserted into the tubular head. The at least one stopper assembly may be configured to prevent movement of the door past a desired position.

According to another embodiment, a method of using a device is also disclosed herein. The method includes providing the device as above; attaching the first attachment plate to the door; attaching the second attachment plate to the door frame; and preventing movement of the door past a desired position via the at least one stopper assembly.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a door stopper device, constructed and operative according to the teachings of the present disclosure.

FIG. 1 is a front view of a device during an ‘in-use’ condition, according to an embodiment of the disclosure.

FIG. 2 is a bottom-front view of the device of FIG. 1 showing a first stopper assembly according to an embodiment of the present disclosure.

FIG. 3 is a bottom-front of the device of FIG. 1 showing the first stopper assembly according to an embodiment of the present disclosure.

FIG. 4 is a left side-front view of the device of FIG. 1 showing the first stopper assembly and a second stopper assembly according to an embodiment of the present disclosure.

FIG. 5 is a right side-front view of the device of FIG. 1 showing the first stopper assembly and the second stopper assembly according to an embodiment of the present disclosure.

FIG. 6 is a flow diagram illustrating a method of using the device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a doorstop and more particularly to a door stopper device as used to hold a door in a desired position, such as in an open position or a closed position. The door stopper device is preferably easily installed for use with virtually any swinging door (about a vertical axis) and does not require the removal of door hardware to install.

Generally disclosed is a door stopper that may be independent from a door, in that the door stopper may function independently without utilizing existing hardware on the door. This may allow use of the door stopper with most doors. The door stopper may prevent the door from moving past a desired position. For example, the door stopper may prevent the door from opening too wide. The door stopper may also be adjustable. In some embodiments, the door stopper may also include a child safety lock. In this embodiment, the door stopper and child safety lock may be configured to lock the door in a closed position.

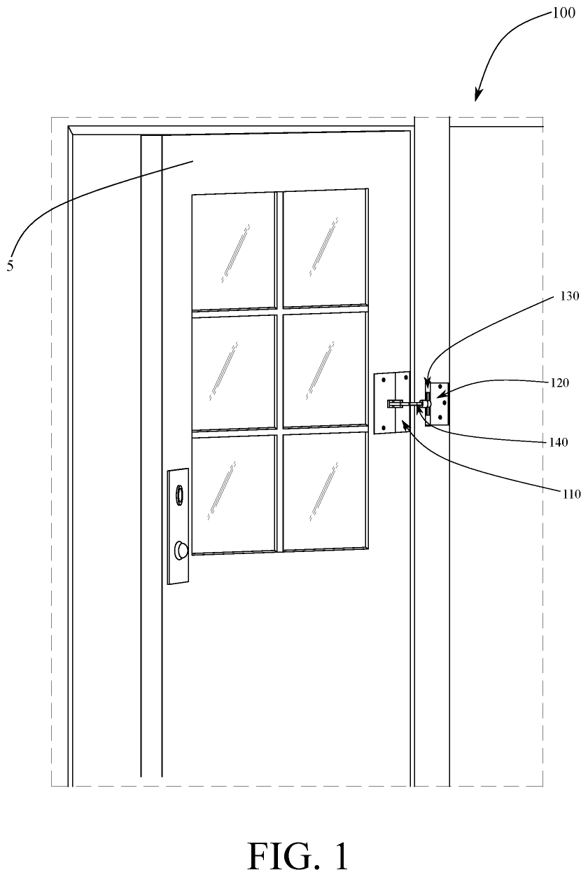

Referring now more specifically to the drawings by numerals of reference, there is shown in FIGS. 1-5, various views of a device 100.

FIG. 1 shows a device 100 during an ‘in-use’ condition, according to an embodiment of the present disclosure. As illustrated, the device 100 may include a first attachment plate 110, a second attachment plate 120, a hinge 130, and at least one stopper assembly 140. The device 100 may be used for substantially preventing movement of a door 5, the door 5 being movable between an open position and a closed position via at least one door hinge, the open position including a varying degree of said open positions.

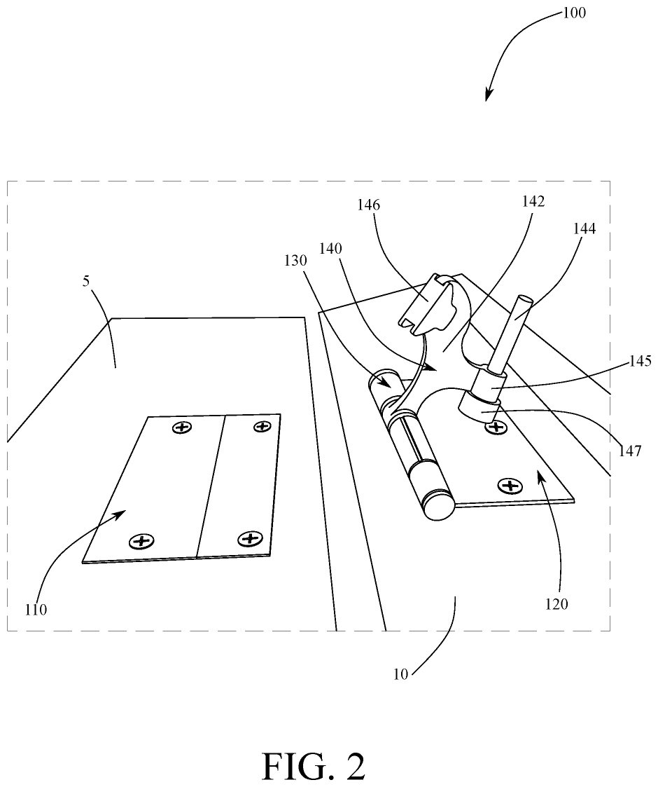

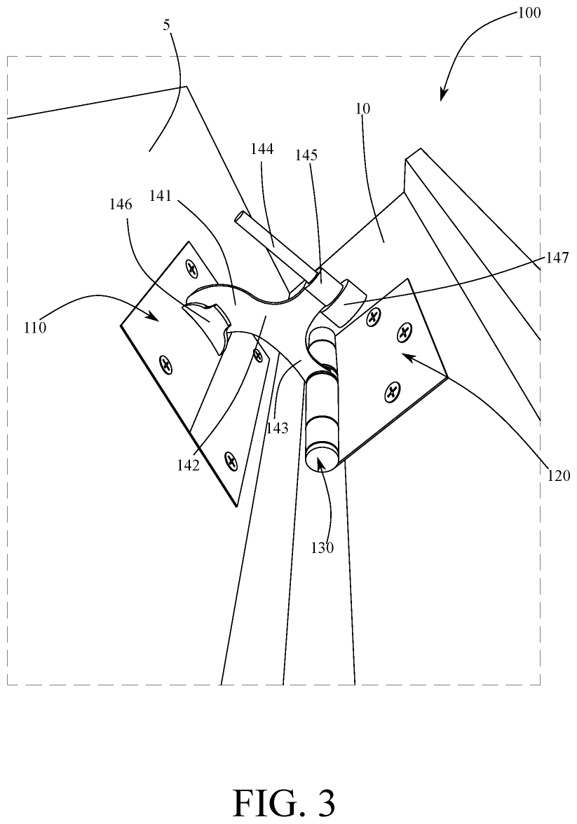

Referring now to FIGS. 2-3 showing various views of the device 100 of FIG. 1, according to an embodiment of the present disclosure. The first attachment plate 110 may be configured to attach to the door 5. Preferably, the first attachment plate 110 may be configured to attach to the door 5 cleanly—in that no damage is made to the door 5. For example, the first attachment plate 110 may be attached to the door 5 via adhesive means such as self-adhesive screws. However, other attachment means may also be contemplated. Whilst it is preferable that the first attachment plate 110 is attached to the door 5 without causing damage to the door 5, in some embodiments, the first attachment plate 110 may be attached to the door 5 via permanent means.

The second attachment plate 120 may be configured to attach to a door frame 10 adjacent the door 5 in use. The second attachment plate 120 may also be attached or installed onto the door frame 10 without causing damage. However, in some embodiments, to provide stability, the second attachment plate 120 may be attached to the door frame 10 via screws. The screws may be 2 inches in length for example. The screws may fasten to behind a door frame casing and drywall adjacent the door 5. This may provide additional support to the device 100 when in use. To further aid in stability, the first attachment plate 110 and the second attachment plate 120 may comprise a steel material. However, other materials are also contemplated.

As shown, the hinge 130 may be attached to the second attachment plate 120. Preferably, the hinge 130 may be integral to the second attachment plate 120. The hinge 130 may be a barrel hinge including a pin for allowing rotation of the same. In some embodiments, the hinge 130 may also be made from the steel material, but again, other materials are also contemplated. The at least one stopper assembly 140 may be configured to selectively pivot about a vertical axis 131 via the hinge 130. The addition of the hinge 130 may prevent a need to utilize existing hinges of the door 5 and may enable use of the device 100 on doors with sealed hinges.

The at least one stopper assembly 140 may be configured to prevent movement of the door 5 past a desired position. For example, the at least one stopper assembly 140 may hold the door 5 in the open position at a 90-degree angle. The at least one stopper assembly 140 may include a body 142 and a stopper rod 144. As shown, the stopper rod 144 may include a cap 147. The cap 147 may protect the door frame 10 and the second attachment plate 120. The body 142 may include a left arm 141, a right arm 143 and a tubular head 145 attached about a mid-section thereof. The right arm 143 may be fixedly attached to the hinge 130 and the left arm 141 may include a fastener means 146 configured to removably attach the left arm 141 to the first attachment plate 110. The fastener means 146 may be a self-adhesive bracket, screw, etc. The fastener means 146 may removably or permanently attach the left arm 141 to the first attachment plate 110.

The stopper rod 144 may be inserted into the tubular head 145. In some embodiments, the stopper rod 144 may include male threads and the tubular head may include female threads. The stopper rod 144 may be threaded into the tubular head 145. Preferably, a length of the stopper rod 144 may be adjustable. In the thread embodiment, the length of the stopper rod 144 may be adjustable via selective unscrewing and screwing of the stopper rod 144 through the tubular head 145. Adjusting the length of the stopper rod 144 may dictate a degree to which the door 5 is held open. For example, as above, the at least one stopper assembly 140 may hold the door in the open position at a 90-degree angle. If a user desires the door to be held open at a 45-degree angle, they may extend the length of the stopper rod (either by screwing the stopper rod tighter or another method).

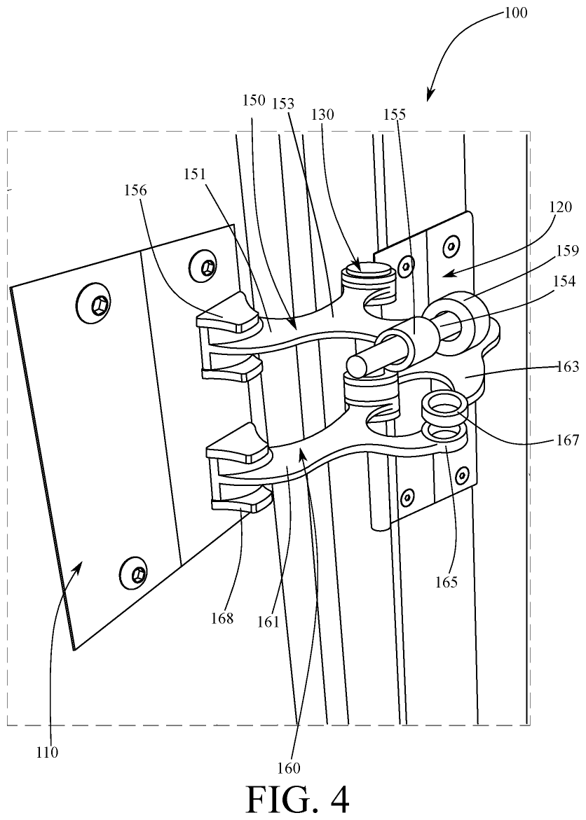

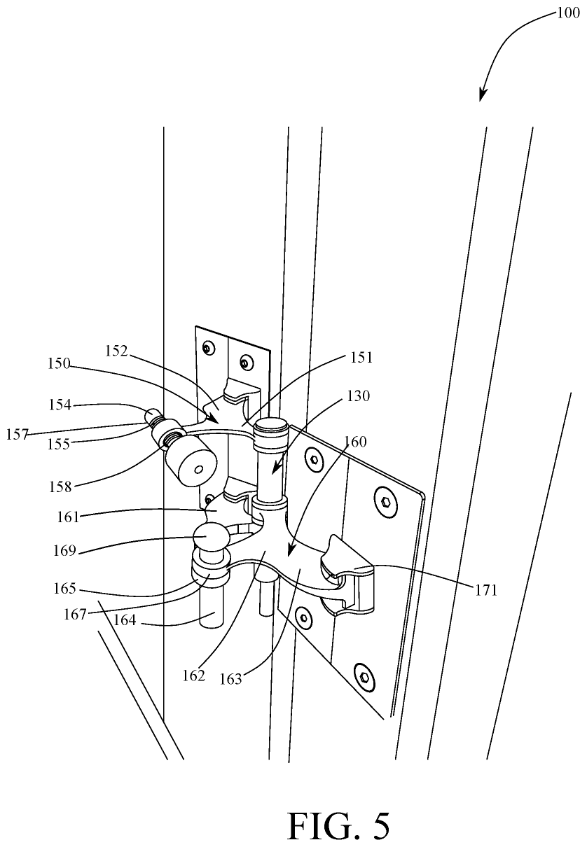

Referring now to FIGS. 4-5 showing various views of the device 100 of FIG. 1, according to an embodiment of the present disclosure. In some embodiments, the at least one stopper assembly 140 may include a first stopper assembly 150 and a second stopper assembly 160. The first stopper assembly 150 may include the same configuration and elements as discussed above with the at least one stopper assembly 140 and as is shown in FIGS. 2-3.

The first stopper assembly 150 may include a first body 152 and a first stopper rod 154. The first stopper rod 154 may include a first cap 159 attached to an end thereof. The first body 152 may include a first left arm 151, a first right arm 153, and a first tubular head 155. The first stopper rod 154 may be insertable into the first tubular head 155 and may be adjustable, as discussed above, as a length of the first stopper rod 154 may be adjusted such that a desired degree of open position 15 of the door can be achieved. Again, similar to above, the first stopper rod 154 may include a first male thread 157 and the first tubular head 155 may include a first female thread 158 configured to mate with the first stopper rod 154. The first left arm 151 may include a first fastener means 156 configured to removably attach the first left arm 151 to the first attachment plate 110 and the first right arm 153 may be fixedly attached to the hinge 130.

In this embodiment shown in FIGS. 4-5, whereby the at least one stopper assembly 140 includes the first stopper assembly 150 and the second stopper assembly 160, the second stopper assembly 160 may act as a child safety lock. In this embodiment, the second stopper assembly 160 may be selectively activated and may lock the door 5 in the closed position 20. The second stopper assembly 160 may be permanent to the device 100 or may be removable. The second stopper assembly 160 may include a second body 162 and a second stopper rod 164. Similar to above, the second stopper rod 164 may include a second cap 169 attached to an end thereof. The second body 162 may include a second left arm 161, a second right arm 163, a second tubular head 165 and a third tubular head 167. The second left arm 161 may include a second fastener means 168 configured to removably attach the second left arm 161 to the second attachment plate 120, and the second right arm 163 may include a third fastener means 171 configured to removably attach the second right arm 163 to the second attachment plate 120.

The second stopper rod 164 may be insertable through the second tubular head 165 and the third tubular head 167. This embodiment of the second stopper rod 164 may be similar to the embodiment discussed and shown with the first stopper assembly 150 (and the at least one stopper assembly 140). For example, in some embodiments, female and male threads may also be utilized with the second stopper rod 164 and the second and third tubular head 167, and the second stopper rod 164 may be adjustable. In other embodiments, the second stopper rod 164 may include a push pin configured to selectively engage and disengage at least one of the second tubular head 165 and the third tubular head 167. FIG. 4 demonstrates the push pin (second stopper rod 164) being disengaged from the second tubular head 165 and the third tubular head 167 and FIG. 5 demonstrates the push pin (second stopper rod 164) being engaged, and thereby locking the door.

For example, apertures in the second tubular head 165 and the third tubular head 167 may interlock (as shown in FIG. 4), and the push pin may be engaged when it is inserted therethrough. When the second stopper rod 164 is inserted through the second tubular head 165 and the third tubular head 167 the door 5 may be locked in the closed position 20. In the push pin embodiment, when the push pin is not engaged, as in the push pin is not inserted through both the second tubular head 165 and the third tubular head 167, the door 5 may be opened. To aid in security of the device 100, the first stopper rod 154 and the second stopper rod 164 may both be made from steel material. However, other materials are contemplated.

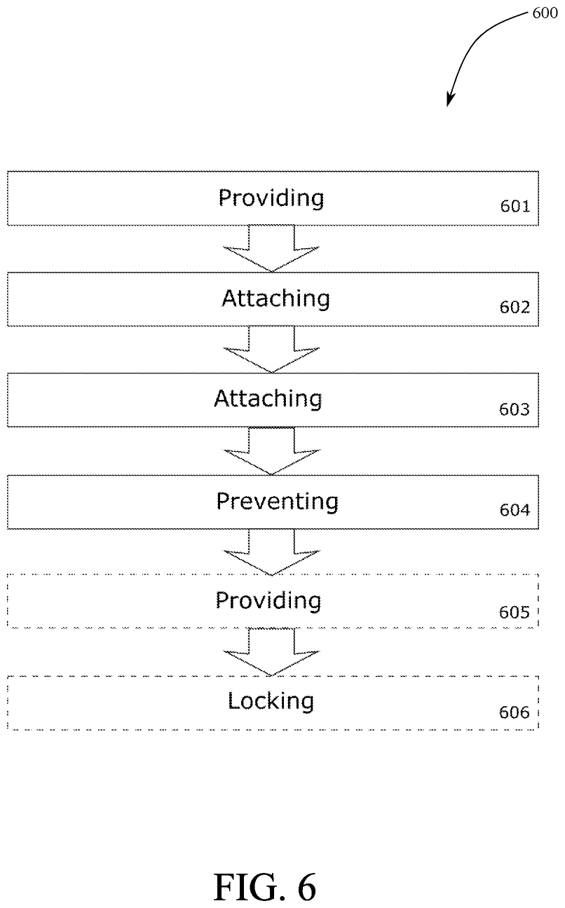

Referring now to FIG. 6 showing a flow diagram illustrating method 600 of using a device, according to an embodiment of the present disclosure. In particular, the method 600 may include one or more components or features of the device 100 as described above. As illustrated, the method of use 600 may include the steps of: step one 601, providing the device as above; step two 602, attaching the first attachment plate to the door; step three 603, attaching the second attachment plate to the door frame; and step four 604, preventing movement of the door past a desired position via the at least one stopper assembly. Further steps may include: step five 605 providing the device whereby it includes the first stopper assembly and the second stopper assembly; and step six 606, locking the door in the closed position via insertion of the second stopper rod through the second tubular head and the third tubular head.

It should be noted that step five 605 and step six 606 are optional steps and may not be implemented in all cases. Optional steps of the method 600 are illustrated using dotted lines in FIG. 6 so as to distinguish them from the other steps of the method 600. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for using the device 100 are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for substantially preventing movement of a door, the door being movable between an open position and a closed position via at least one door hinge, the open position including a varying degree of said open positions, the device comprising:
a first attachment plate configured to attach to the door;
a second attachment plate configured to attach to a door frame, the door frame being adjacent the door in use;
a hinge attached to the second attachment plate; and
at least one stopper assembly configured to selectively pivot about a vertical axis via the hinge, the at least one stopper assembly including a body and a stopper rod, the body having a left arm, a right arm and tubular head attached about a mid-section thereof, the left arm including a fastener means configured to removably attach the left arm to the first attachment plate, the right arm being fixedly attached to the hinge, the stopper rod being inserted into the tubular head; and
wherein the at least one stopper assembly is configured to prevent movement of the door past a desired position.

2. The device of claim 1, wherein the at least one stopper assembly includes a first stopper assembly and a second stopper assembly.

3. The device of claim 2, wherein the first stopper assembly includes a first body and a first stopper rod, the first body having a first left arm, a first right arm, and a first tubular head, the first left arm including a first fastener means configured to removably attach the first left arm to the first attachment plate, the first right arm fixedly attached to the hinge, the first stopper rod being insertable into the first tubular head.

4. The device of claim 3, wherein the second stopper assembly includes a second body and a second stopper rod, the second body having a second left arm, a second right arm, a second tubular head and a third tubular head, the second left arm including a second fastener means configured to removably attach the second left arm to the second attachment plate, the second right arm including a third fastener configured to removably attach the second right arm to the second attachment plate.

5. The device of claim 4, wherein the second stopper rod is insertable through the second tubular head and the third tubular head.

6. The device of claim 5, wherein the second stopper rod includes a push pin configured to selectively engage and disengage at least one of the second tubular head and the third tubular head.

7. The device of claim 6, wherein when the second stopper rod is inserted through the second tubular head and the third tubular head, the door is locked in the closed position.

8. The device of claim 3, wherein the first stopper rod is adjustable.

9. The device of claim 8, wherein the first stopper rod includes a first male thread, and the first tubular head includes a first female thread configured to mate with the first stopper rod.

10. The device of claim 9, wherein the first stopper rod includes a first cap attached to an end thereof.

11. The device of claim 7, wherein the second stopper rod is adjustable.

12. The device of claim 11, wherein the second stopper rod includes a second cap attached to an end thereof.

13. The device of claim 1, wherein the first attachment plate is attached to the door via self-adhesive screws.

14. The device of claim 13, wherein the first attachment plate and the second attachment plate comprise a steel material.

15. The device of claim 14, wherein the first body and the second body comprise the steel material.

16. The device of claim 15, wherein the first stopper rod and the second stopper rod are made from the steel material.

17. A device for substantially preventing movement of a door, the door being movable between an open position and a closed position via at least one door hinge, the open position including a range of said open positions, the device comprising:
a first attachment plate configured to attach to the door;
a second attachment plate configured to attach to a door frame, the door frame being adjacent the door;
a hinge attached to the second attachment plate;
a first stopper assembly configured to selectively pivot about a vertical axis via the hinge, the first stopper assembly including a first body and a first stopper rod, the first body having a first left arm, a first right arm, and a first tubular head, the first left arm including a first fastener means configured to removably attach the first left arm to the first attachment plate, the first right arm fixedly attached to the hinge, the first stopper rod being inserted into the first tubular head; and
a second stopper assembly configured to selectively pivot about the vertical axis via the hinge, the second stopper assembly including a second body and a second stopper rod, the second body having a second left arm, a second right arm, a second tubular head and a third tubular head, the second left arm including a second fastener means configured to removably attach the second left arm to the second attachment plate, the second right arm including a third fastener configured to removably attach the second right arm to the second attachment plate, the second stopper rod being insertable through the second tubular head and the third tubular head; and
wherein the first stopper assembly and the second stopper assembly are configured to prevent movement of the door past a desired position; and
wherein when the second stopper rod is inserted through the second tubular head and the third tubular head, the door is locked in the closed position.

18. The device of claim 17, wherein the first stopper rod includes a first cap attached to an end thereof and wherein the second stopper rod includes a second cap attached to an end thereof.

19. A method of using a device for substantially preventing movement of a door, the door being movable between an open position and a closed position via at least one door hinge, the open position including a varying degree of open positions, the method comprising the steps of:
providing the device including:
a first attachment plate configured to attach to the door;
a second attachment plate configured to attach to a door frame, the door frame being adjacent the door;
a hinge attached to the second attachment plate;
at least one stopper assembly configured to selectively pivot about a vertical axis via the hinge, the at least one stopper assembly including a body and a stopper rod, the body having a left arm, a right arm and tubular head attached about a mid-section thereof, the left arm including a fastener means configured to removably attach the left arm to the first attachment plate, the right arm being fixedly attached to the hinge, the stopper rod being inserted into the tubular head; and
attaching the first attachment plate to the door;
attaching the second attachment plate to the door frame; and
preventing movement of the door past a desired position via the at least one stopper assembly.

20. The method of claim 19, further comprising the steps of:
providing the device, wherein the at least one stopper assembly includes:
a first stopper assembly including:
a first body and a first stopper rod, the first body having a first left arm, a first right arm, and a first tubular head, the first left arm including a first fastener means configured to removably attach the first left arm to the first attachment plate, the first right arm fixedly attached to the hinge, the first stopper rod being inserted into the first tubular head; and
a second stopper assembly including:
a second body and a second stopper rod, the second body having a second left arm, a second right arm, a second tubular head and a third tubular head, the second left arm including a second fastener means configured to removably attach the second left arm to the second attachment plate, the second right arm including a third fastener configured to removably attach the second right arm to the second attachment plate, the second stopper rod being insertable through the second tubular head and the third tubular head; and
locking the door in the closed position via insertion of the second stopper rod through the second tubular head and the third tubular head.
